(19) United States
(12) Patent Application Publication
(10) Pub. No.: US 2014/0369676 A1
(43) Pub. Date: Dec. 18, 2014

(54) PON SYSTEM, OLT, AND ONU

(71) Applicant: Akihiro Hamaoka, Tokyo (JP)

(72) Inventor: Akihiro Hamaoka, Tokyo (JP)

(73) Assignee: Mitsubishi Electric Corporation, Tokyo (JP)

(21) Appl. No.: 14/374,402

(22) PCT Filed: Mar. 22, 2012
(86) PCT No.: PCT/JP2012/001986

§ 371 Date: Jul. 24, 2014

(51) Int. Cl. H04B 10/079; H04B 10/27

(52) U.S. Cl. CPC H04B 10/0795; H04B 10/27
USPC 398/25

(57) ABSTRACT

An OLT includes an ONU link state monitor that monitors a registered state of each of the ONUs, a continuous light-emission monitor that detects a continuous light-emitting state on the basis of a monitor result given by the ONU link state monitor, and identifies an ONU being in continuous light-emission, and an optical output power shut down command unit that commands the ONU identified by the continuous light-emission monitor to shut down the optical output power. Each of the ONU includes an optical transmitter and receiver device that transmits and receives an optical signal to/from the OLT, and a light output controller that shuts down light of the optical transmitter and receiver device in response to the command given by the optical output power shut down command unit.

### TECHNICAL FIELD

The present invention relates to a multi-branching communication system (PON system; a passive optical network system) in which a plurality of subscriber devices (ONUs; optical line units) share an optical fiber to transmit data to a station device (OLT; an optical line terminal), more particularly, relates to a PON system, an OLT, and an ONU, in which the OLT detects abnormality of the ONU.

### BACKGROUND ART

A PON system is a subscriber access system in which one optical fiber circuit is shared by multiple subscribers (users). In particular, a GE-PON system having a communication speed of Giga-bit order between a telecommunication carrier and multiple users is being widely spread. The GE-PON system is configured such that an optical transmission path (an optical fiber) connected to an interface board implemented in the OLT is branched into multiple paths by an optical splitter (a star coupler), and the ONU is connected to each branched optical fiber. According to this configuration, the OLT and the multiple ONUs are able to perform bidirectional communication through the single optical fiber via the optical splitter. Access from the ONU to the OLT employs a method of performing burst transmission and reception, in which each ONU shares time slots of a single optical fiber circuit. According to this method, a point to multi-points connection between, for example, one OLT and thirty-three ONUs can be realized.

In the PON system mentioned above, in a case where an ONU malfunctions and burst transmission of an uplink frame becomes uncontrollable and thereby continuous light-emitting state arises, the other ONUs are unable to communicate due to interference between uplink frames of the malfunctioning ONU and uplink frames of the other ONUs. For such case, a technique is known (for example, see Patent Literatures 1 and 2), which is for determining the malfunctioning ONU, solving the continuous light-emitting state, and stabilizing the system operation.

In Patent Literature 1, the OLT measures, as a light reception electric power of continuous light-emission, a light reception electric power being obtained on an assumption that band allocations for all ONUs are removed. Then the OLT compares the measured light reception electric power with a light reception electric power measurement result of each ONU one by one, thus identifying a subscriber station being in malfunction.

In Patent Literature 2, each ONU has a mechanism of detecting an optical signal from the OLT and shutting off an optical signal output from the ONU itself when a link with the OLT is disconnected. On the other hand, the OLT identifies a malfunctioning subscriber station by detecting recovery of a link state with the other ONUs when the subscriber station being in continuous light-emitting state is shutting off the light output.

### CITATION LIST

Patent Literature 1: Japanese Patent Laid-Open No. 2002-359596

Patent Literature 2: Japanese Patent Laid-Open No. 2011-055264

### SUMMARY OF INVENTION

However, Patent Literature 1 is an invention mainly designed to identify an ONU that is malfunctioning. In addition, the OLT has to measure the received optical power from each of the ONUs in order to identify a malfunctioning portion (i.e. an ONU being in continuous light-emission), and there is a problem in that it takes a long time to identify the ONU when there are many ONUs connected. Furthermore, since the received optical power in the continuous light-emitting state and the received optical power from each ONU are compared, there is a problem in that a malfunctioning portion cannot be identified in a case where there is no difference in measurement result of the optical reception electric power of the ONU.

In Patent Literature 2, the ONU additionally has a function for detecting the continuous light-emitting state, and therefore, there is a problem in that the cost increases. In addition, in a system in which the OLT accommodates ONUs made by different manufactures, there is a problem in that all the connected ONUs need to support the detection function.

The present invention has been made to solve the above-described problem, and has an object to provide a PON system, an OLT, and an ONU being capable of identifying an ONU being in continuous light-emission without adding any special detection circuits (or functions) to the OLT and the ONUs.

A PON system according to the present invention includes an OLT and a plurality of ONUs connected to the OLT, wherein the OLT includes: an ONU link state monitor that monitors a registered state of each of the ONUs; a continuous light-emission monitor that detects a continuous light-emitting state on the basis of a monitor result given by the ONU link state monitor, and identifies an ONU being in continuous light-emission; and an optical output power shut down command unit that commands the ONU identified by the continuous light-emission monitor to shut down the optical output power, and wherein the ONU includes: an optical transmitter and receiver device that transmits and receives an optical signal to/from the OLT; and a light output controller that shuts down light of the optical transmitter and receiver device in response to the command given by the light shut down command unit.

According to the present invention, as described above, since a method is employed to identify an ONU being in continuous light-emission without adding any special detection circuits (or functions) to the OLT and the ONUs, there is an effect of making an inexpensive configuration without increase in the cost.

### BRIEF DESCRIPTION OF DRAWINGS

FIG. 1 is a figure illustrating a configuration of a PON system according to Embodiment 1 of the present invention.

FIG. 2 is a schematic view illustrating operation when an uplink signal is normal in the PON system according to the Embodiment 1 of the present invention.

FIG. 3 is a schematic view illustrating operation when an uplink signal is abnormal in the PON system according to the Embodiment 1 of the present invention.

FIG. 4 is a schematic diagram illustrating the state after uplink signal abnormal state recovery in the PON system according to the Embodiment 1 of the present invention.

FIG. 5 is an example of flowchart illustrating operation of a continuous light-emission monitor controller according to the Embodiment 1 of the present invention.

FIG. 6 is an example of state of a link state management table when an uplink signal is normal in the PON system according to the Embodiment 1 of the present invention.

FIG. 7 is an example of state of the link state management table when an uplink signal is abnormal in the PON system according to the Embodiment 1 of the present invention.

FIG. 8 is an example of state of the link state management table when an ONU power supply is shut off in the PON system according to the Embodiment 1 of the present invention.

FIG. 9 is an example of state of the link state management table when an optical fiber is disconnected in the PON system according to the Embodiment 1 of the present invention.

FIG. 10 is a schematic view illustrating operation when an uplink signal is abnormal in the PON system according to a Embodiment 2 of the present invention.

FIG. 11 is a figure illustrating a configuration of a PON system according to the Embodiment 2 of the present invention.

FIG. 12 is an example of state of the link state management table when an uplink signal is abnormal in the PON system according to the Embodiment 2 of the present invention.

FIG. 13 is an example of flowchart illustrating operation of a continuous light-emission monitor controller according to the Embodiment 2 of the present invention.

FIG. 14 is a figure illustrating a configuration of a PON system according to a Embodiment 3 of the present invention.

FIG. 15 is a schematic view illustrating operation when an uplink signal is normal in the PON system according to the Embodiment 3 of the present invention.

FIG. 16 is a schematic view illustrating operation when an uplink signal is abnormal in the PON system according to the Embodiment 3 of the present invention.

FIG. 17 is an example of flowchart illustrating operation of a light burst monitor according to the Embodiment 3 of the present invention.

FIG. 18 is an example of flowchart illustrating operation of a continuous light-emission monitor controller according to the Embodiment 3 of the present invention.

### DESCRIPTION OF EMBODIMENTS

Embodiments of the present invention will be hereinafter explained in details with reference to drawings.

### Embodiment 1

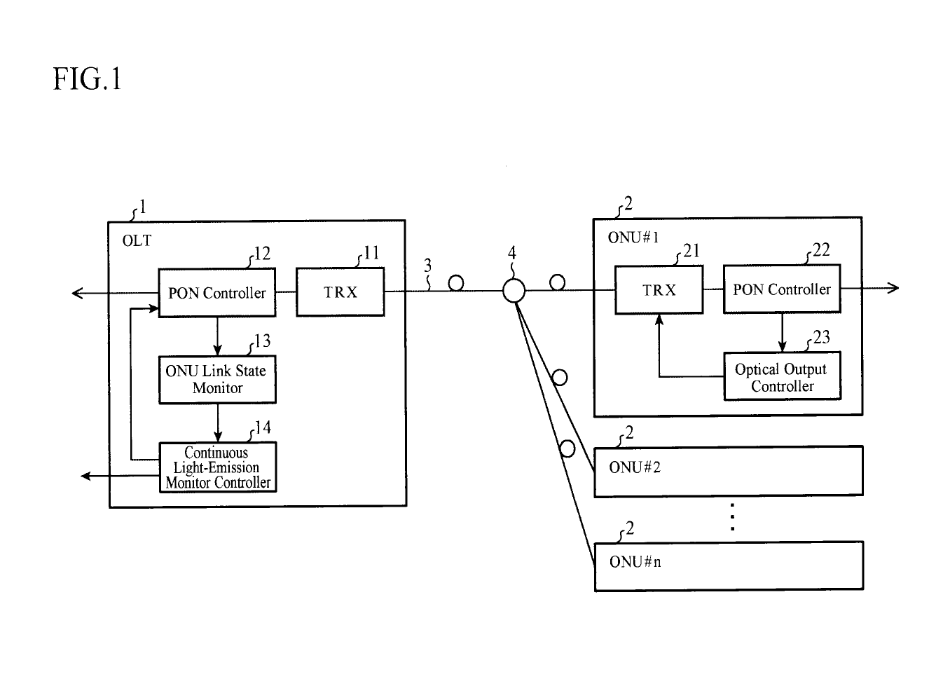

FIG. 1 is a figure illustrating a configuration of a PON system according to Embodiment 1 of the present invention.

As shown in FIG. 1, the PON system comprises an optical line terminal (OLT) 1 and multiple optical network units (ONUs) 2. This OLT 1 can be connected to each ONU 2 via an optical fiber 3 and an optical splitter 4. In FIG. 1, n ONUs 2 (ONUs #1 to #n) are shown.

The OLT 1 includes an optical transmitter and receiver device (TRX; Transceiver) 11, a PON controller 12, an ONU link state monitor 13, and a continuous light-emission monitor controller 14.

The optical transmitter and receiver device 11 transmits and receives an optical signal to/from an optical transmitter and receiver device 21, explained later, of each of the ONUs 2.

The PON controller 12 performs access control based on the PON system against each of the ONUs 2. The PON controller 12 controls the optical transmitter and receiver device 11 to notify a corresponding ONU 2 of a command in response to optical output power shut down command and a warning notification each of which are given by the continuous light-emission monitor controller 14.

The ONU link state monitor 13 monitors the link state of each of the ONUs 2. This ONU link state monitor 13 monitors a registered state (“Registered” or “Deregistered”) of each of the ONUs 2 as the link state of the ONU 2.

The continuous light-emission monitor controller 14 has a function (as a continuous light-emission monitor) of detecting a continuous light-emitting state (an abnormal light-emission state) on the basis of the monitor result of the ONU link state monitor 13 and identifying an ONU 2 being in continuous light-emission. The continuous light-emission monitor controller 14 also has a function (as optical output power shut down command unit) of giving a warning notification to the PON controller 12 and giving optical output power shut down notification to the corresponding ONU.

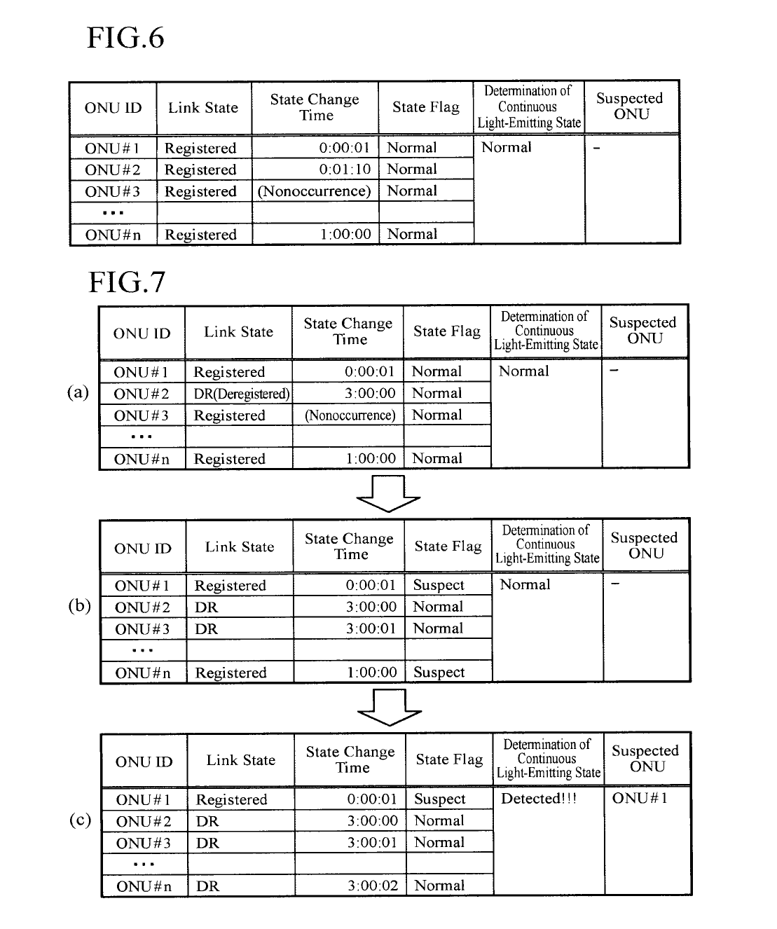

The continuous light-emission monitor controller 14 holds, for example, a link state management table such as shown in FIG. 6. The link state management table describes IDs (ONU IDs) of each of the ONUs 2, a link state (“Registered” or “Deregistered; DR”), a time when the link state changed (a state change time), a state flag (“Normal” or “Suspect”), a continuous light-emitting state determination, an ONU 2 which is suspected of continuously emitting light (i.e. an suspected ONU), which are described in such a manner that they are associated with each other.

The ONU 2 includes an optical transmitter and receiver device (TRX: Transceiver) 21, a PON controller 22, and an optical output controller 23.

The optical transmitter and receiver device 21 transmits and receives an optical signal to/from the optical transmitter and receiver device 11 of the OLT 1.

The PON controller 22 performs access control based on the PON system against the OLT 1.

The optical output controller 23 receives a command from the OLT 1, and performs optical output control such as optical output shut down of the optical transmitter and receiver device 21.

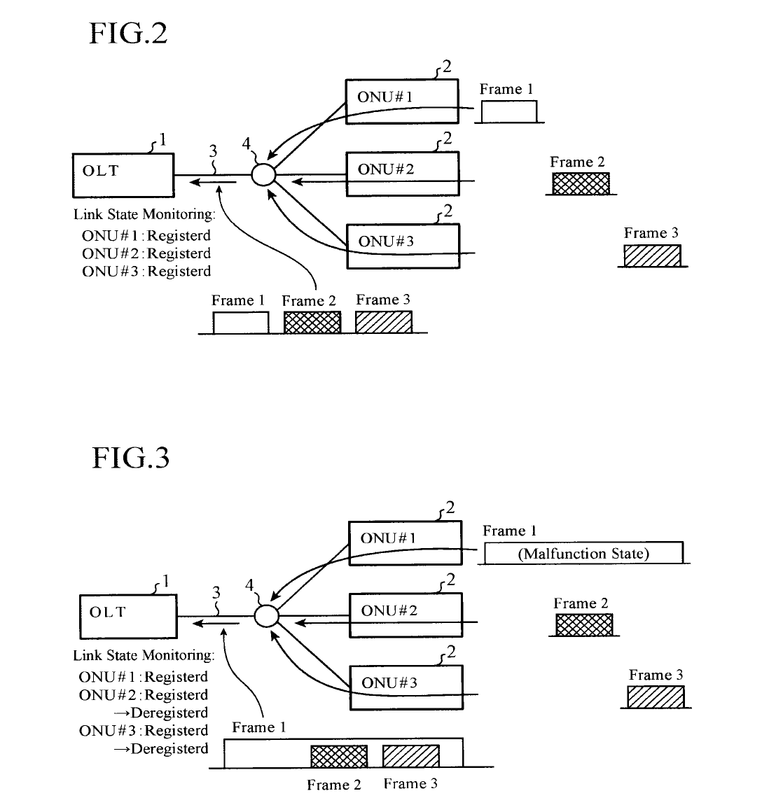

Subsequently, overview of operation of the PON system configured as described above will be explained with reference to FIGS. 2 to 4. FIGS. 2 to 4 show a case where three ONUs 2 (ONUs #1 to #3) are connected.

FIG. 2 is a figure illustrating overview of operation when each ONU 2 is normal. As shown in FIG. 2, an uplink frame (a packet) which is input into each ONU 2 from a host terminal (not shown) is transmitted to the OLT 1 at individual timings each of which is time-divisionally controlled. In a case when the ONU 2 is normal, since the frames received by the OLT 1 do not collide with each other and are transferred in a time-division multiplexing manner, the OLT 1 is in such state that each ONU 2 is registered as normal.

FIG. 3 is a figure illustrating overview of operation when the ONU #1 malfunctions and the optical output of the ONU #1 becomes continuous light-emission. As shown in FIG. 3, when the ONU #1 continuously emits light, the signal received by the OLT l is in such state that a frame 1 and frames 2-3 collide with each other, and the OLT 1 is in such state that the OLT 1 is unable to correctly receive the frames 2-3. Therefore, the OLT 1 is in such state that only the ONU #1 is registered, and the OLT 1 is unable to communicate with the ONUs #2 and #3, which are in the deregistered state (i.e. “Deregistered”)

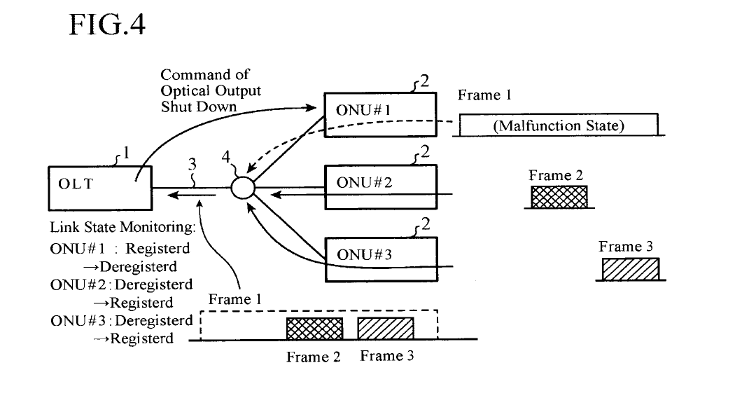

In contrast, FIG. 4 is a figure illustrating overview of operation in a case where the ONU #1 being in continuous light-emission is detected. As shown in FIG. 4, the OLT 1 identifies the ONU #1 being in continuous light-emission by detecting the continuous light-emitting state, and thereafter, gives an optical output shut down command to the ONU #1. As a result, the frame 1 that is colliding with the frames 2-3 is eliminated, and the OLT 1 recovers back to such state that the OLT 1 is able to receive the frames 2-3, and the ONUs #2 and #3 are returned back to the registered state (i.e. “Registered”).

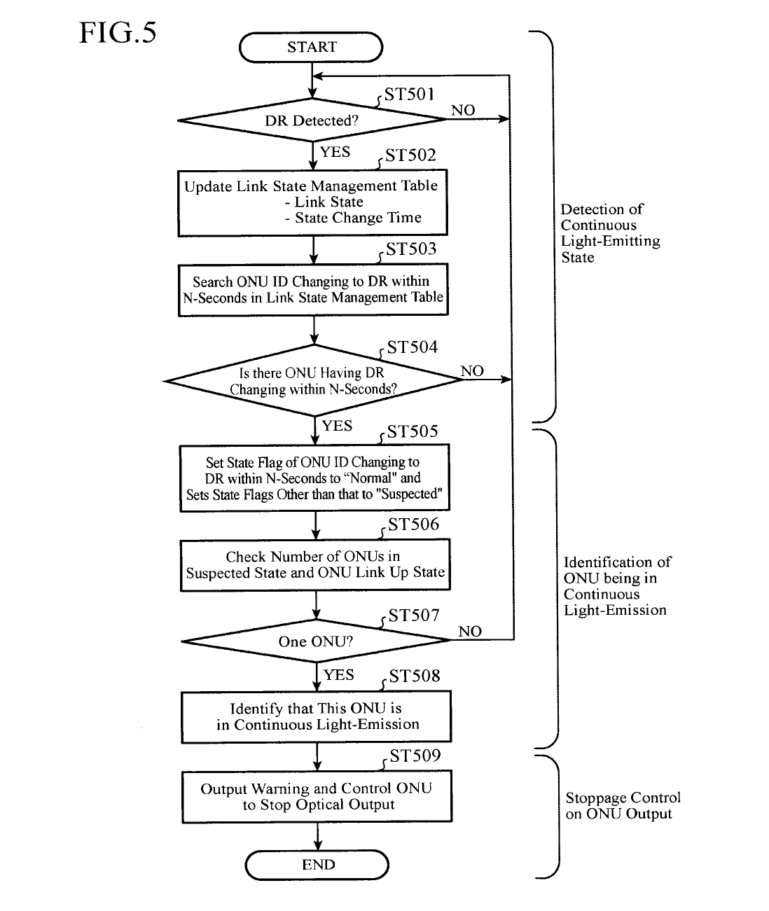

Subsequently, a specific operation performed by the continuous light-emission monitor controller 14 of the OLT 1 will be explained with reference to FIGS. 5 to 9. The specific operation includes a detection of the continuous light-emitting state, an identification of the ONU 2 continuously emitting light, and a command of optical output shut down given to the ONU 2.

When all the ONUs 2 are normal, the link state management table held in the continuous light-emission monitor controller 14 indicates that all the ONUs 2 are in the registered state (“Registered”) as shown in FIG. 6. The state change time is in such state that a different time is held for each of the ONUs 2 or “Nonoccurrence”.

On the other hand, when the light output of any given ONU 2 is continuous light-emission, in the OLT 1, the ONU link state monitor 13 detects that the ONU 2 changes from the registered state to the deregistered state, and notifies the continuous light-emission monitor controller 14 of the detection (for example, in a case where the ONU #1 of the multiple ONUs 2 is continuously emitting light, the ONU #2 is the first to change to the deregistered state).

As shown in FIG. 5, when it is detected that any ONU 2 changes to “DR” (a deregistered state) (step ST501 ‘YES’), the continuous light-emission monitor controller 14 updates the corresponding link state and the corresponding state change time in the link state management table (step ST502). For example, when the ONU #2 changes to the deregistered state, the link state of the ONU #2 is changed from the “Registered” to the “Deregistered” as shown in FIG. 7(a), and the time at this moment is recorded as the state change time.

Subsequently, the continuous light-emission monitor controller 14 scans the ONU ID of an ONU 2 whose state change time is within N seconds against the state change time of the ONU 2 which was detected in step ST502 (step ST503). Note that “N seconds” indicates a constant that is set based on an elapsed time from when an ONU 2 is in the continuous light-emission state till when all other ONUs 2 change to the deregistered state. A set value of the “N seconds” is determined in accordance with the system.

When it is determined that there is no ONU 2 which changed to the deregistered state within N seconds as a result of scanning in step ST503, the processing is terminated, and then step ST501 is performed to be in an DR detection waiting state (step ST504 ‘NO’). For example, FIG. 7(a) shows a case where the ONU #1 continuously emits light, and only the ONU #2 changes to the deregistered state. In this case, it is deemed in step ST504 that there is no ONU 2 which changed to the deregistered state within N seconds, and the processing is once terminated. However, in the continuous light-emitting state, for example, as shown in FIG. 7(b), the ONU #3 immediately changes to the deregistered state, and the processing is operated again in step ST501. Thereafter, in step ST503 for the ONU #3, an ONU #2 which changed to the deregistered state within N seconds is detected, and the sequence proceeds to step ST505 (step ST504 ‘YES’).

Subsequently, the state flag of the ONU 2 which changed to the deregistered state within N seconds is set as Normal state, and the ONUs 2 other than that is set as Suspected state (step ST505). For example, In FIG. 7(b), the state flags of the ONUs #2 and #3 are still the Normal state which are left as they are, and the state flags of the ONUs #1 and #4 to #n other than those are changed to the Suspected state.

Subsequently, the number of ONUs 2, whose state flags indicate the Suspected state, is counted in the link state management table (step ST506).

In this step ST506, when the number of ONUs 2 whose state flags are the Suspected state is zero or two or more, the processing is terminated, and then the sequence returns back to step ST501 (step ST507 ‘NO’). For example, FIG. 7(b) shows a case where the ONU #3 changes to the deregistered state subsequent to the ONU #2. In this case, since there are two or more ONUs 2 being in the Suspected states, the processing is once terminated. However, in the continuous light-emitting state, thereafter, the ONUs up to the ONU #n ultimately change to the deregistered state, and the processes of steps ST501 to ST507 are executed. As a result, as shown in FIG. 7(c), the state flags from the ONUs #2 to #n change to the Normal state, and the number of ONUs 2 in the Suspected state and the registered state is determined to be one in step ST506, and then the sequence proceeds to step ST508 (step ST507 ‘YES’).

Subsequently, the continuous light-emitting state of the PON system is recognized, and the ONU 2 being in the Suspected state (i.e. the ONU #1 in the drawing) is identified as an ONU 2 continuously emitting light (step ST508).

Subsequently, a warning notification indicating the continuous light-emitting state is sent to the PON controller 102, and a notification of optical shut down command is given to the ONU 2 being in continuous light-emission (step ST509). The PON controller 12 having received the warning notification transmits the optical output shut down command to the applicable ONU 2 via the PON section. In the ONU 2, the PON controller 22 recognizes the optical shut down command coming from the OLT 1 and notifies the optical output controller 23 of the light shut down command, and the light output controller 23 controls the optical output shut down of the optical transmitter and receiver device 21. With regard to the optical output shut down, it is done by cutting off the driving power supply for the optical transmitter and receiver device 21 or cutting the LD electric current.

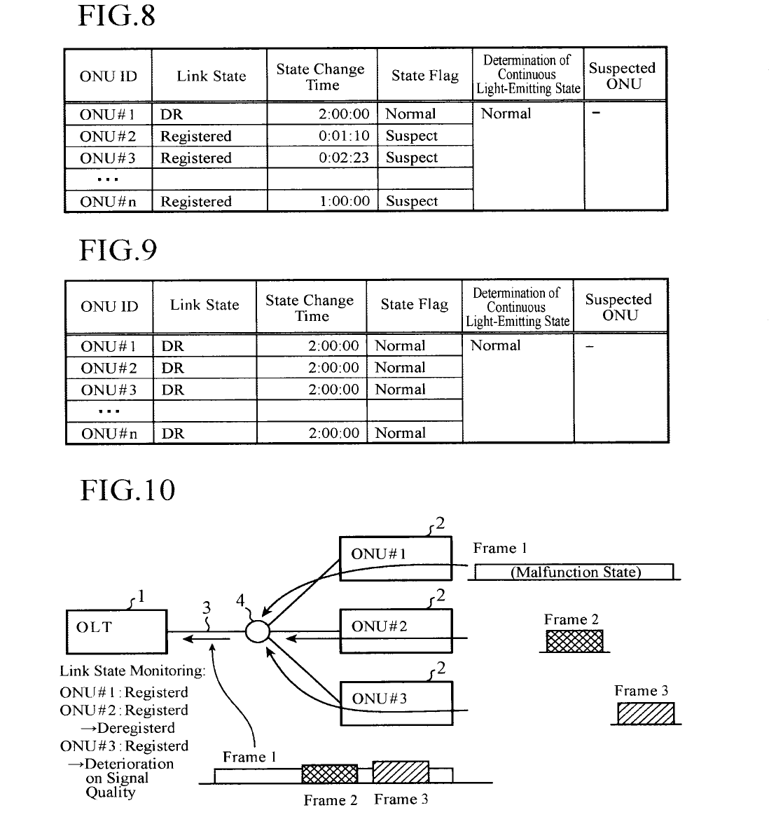

For example, as shown in FIG. 8, in a case where only one ONU 2 (ONU #1) has its power shut off and changes to the deregistered state, there is a low probability that other ONUs 2 (ONU #2 to #n) change to the deregistered state within N seconds. Therefore, the continuous light-emission monitor controller 14 dose not falsely detect the continuous light-emitting state.

For another example, as shown in FIG. 9, in a case where all the ONUs 2 connected to the OLT 1 change to the Deregistered state due to fracture of an optical fiber and the like, the number of ONUs 2 being in the Suspected state is zero. Therefore, the continuous light-emission monitor controller 14 does not falsely detect the continuous light-emitting state.

Note that, in this method, since the continuous light-emission is monitored on the basis of the registered states of multiple ONUs 2, this method is effective when there are three or more ONUs 2 connected to the OLT 1.

As described above, according to this Embodiment 1, in a case where all the ONUs 2 other than one ONU 2 change to the deregistered state within N seconds, the OLT 1 is configured to detect the continuous light-emitting state, and identify that the ONU 2 in question is the ONU 2 being in continuous light-emission, and commands the identified ONU 2 to shut down the optical output power. Therefore, the ONU 2 being in continuous light-emission can be identified without using any special detection circuit in the OLT 1 and the ONUs 2, and the inexpensive configuration can be made without increase in the cost. In addition, this is also effective in a case where ONUs made by different manufacturers are connected with each other. Furthermore, since the continuous light-emission can be automatically detected, identified, and recovered, the outage of the system (i.e. a communication disconnected time) is reduced.

### Embodiment 2

In the Embodiment 1, explanation has been made on the basis of the assumption that, in a case where one ONU 2 continuously emits light, the other ONUs 2 change to the deregistered state. In contrast, as shown in FIG. 10, in a case where the light output level of an ONU #1 being in continuous light-emission is low, while the frame 1 interferes with the frames 2-3 of the other ONUs #2 and #3, the interference is not great enough to completely disable the communication, and the communication is considered to be in a signal deteriorated state such as frame loss and the like. In Embodiment 2, a PON system being able to address the above-mentioned case will be explained.

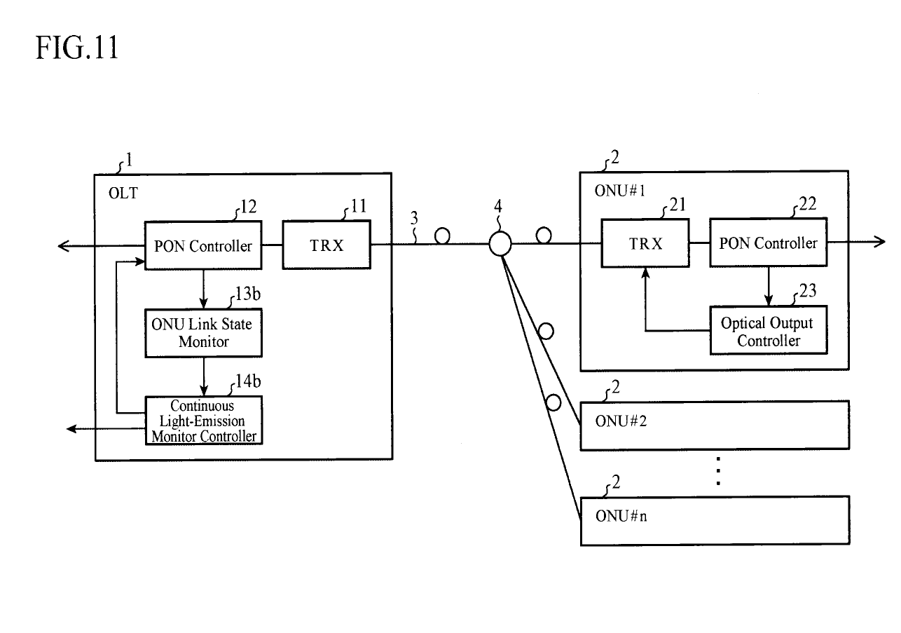

FIG. 11 is a figure illustrating a configuration of the PON system according to the Embodiment 2 of the present invention. In the PON system according to the Embodiment 2 shown in FIG. 11, the ONU link state monitor 13 and the continuous light-emission monitor controller 14 of the PON system according to the Embodiment 1 shown in FIG. 1 are replaced with the ONU link state monitor 13b and the continuous light-emission monitor controller 14b, respectively. The other configuration is the same, and the same reference numerals are attached thereto and explanation thereabout is omitted.

The ONU link state monitor 13b includes not only the function of the ONU link state monitor 13 of the Embodiment 1 shown in FIG. 1, but also a function for monitoring the transmission quality state of each ONU 2 as the link state of the ONU 2.

The continuous light-emission monitor controller 14b has a function (as a continuous light-emission monitor) of detecting continuous light-emitting state (an abnormal light-emission state) on the basis of a monitor result given by the ONU link state monitor 13b and identifying the ONU 2 being in continuous light-emission. The the continuous light-emission monitor controller 14b further has a function (as an optical output power shut down command unit) of giving a warning notification to the PON controller 12 and giving an optical output power shut down notification to the corresponding ONU 2.

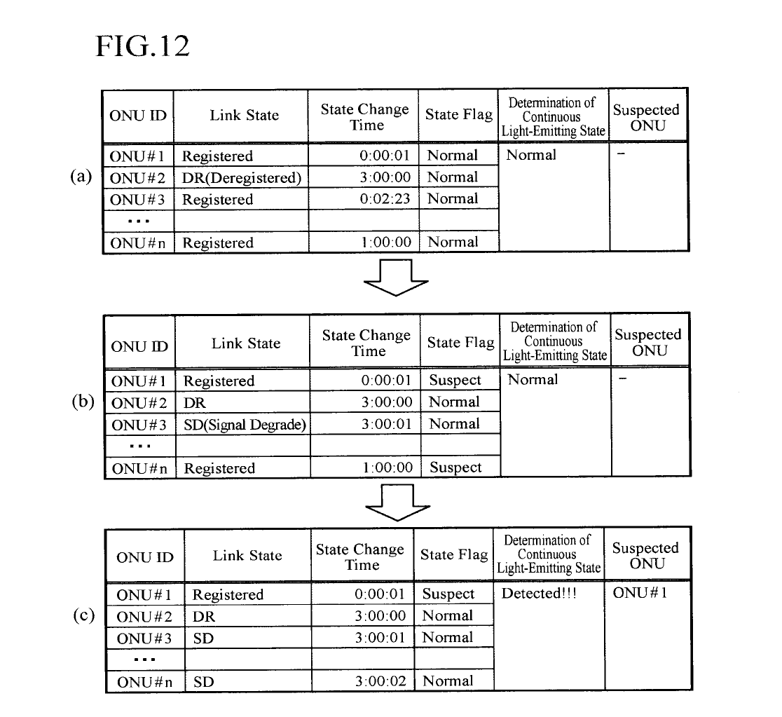

The continuous light-emission monitor controller 14 holds a link state management table as shown in FIG. 12. The link state management table shown in FIG. 12 is different from the link state management table of FIG. 6, in that the link state management table of FIG. 12 manages, as the link state, not only registered states (Registered/Deregistered) but also the transmission quality state (a quality deteriorated state (SD; Signal Degrade)). In addition, not only a time when the registered state changes but also a time when the transmission quality state changes are recorded as the state change time.

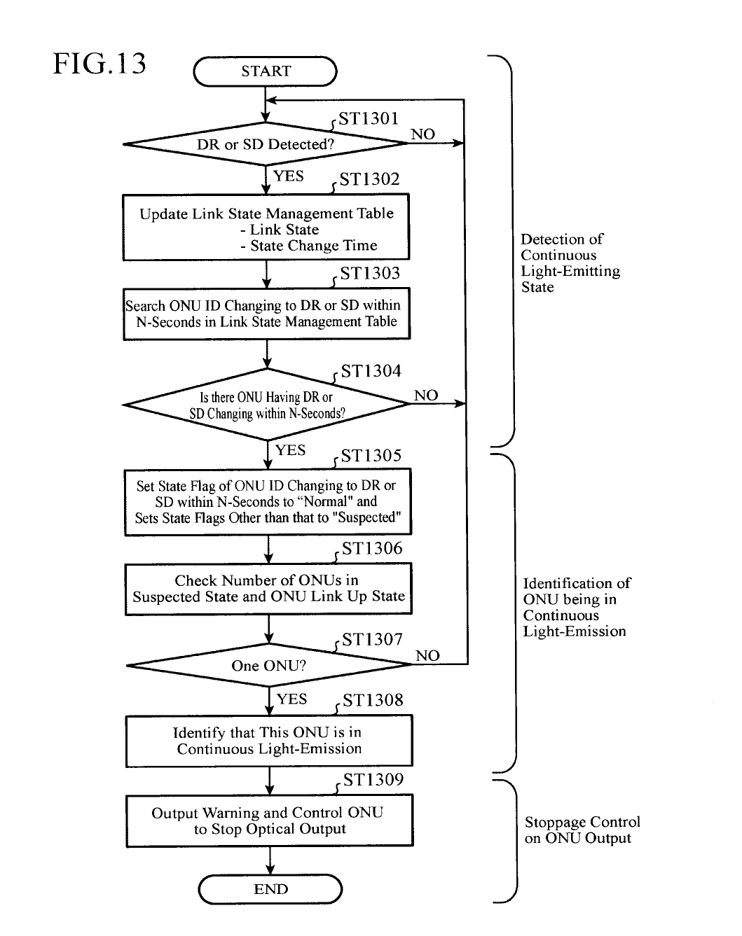

Specific operation of the continuous light-emission monitor controller 14b according to the Embodiment 2 is shown in FIG. 13. More specifically, in the flowchart shown in FIG. 13, not only the deregistered state (DR) but also the quality deteriorated state (SD) are considered in steps ST501, ST503 and ST505 of the flowchart shown in FIG. 5 (step ST1301, 1303 and 1305). The other configuration is the same as that of the Embodiment 1, and explanation of the same one is omitted.

As described above, in the Embodiment 2, not only the registered state but also the transmission quality state (a quality deteriorated state) is monitored as the link state of the ONU 2. Therefore, as compared with the Embodiment 1, the Embodiment 2 can solve wide range of situations where the continuous light-emission occurs.

### Embodiment 3

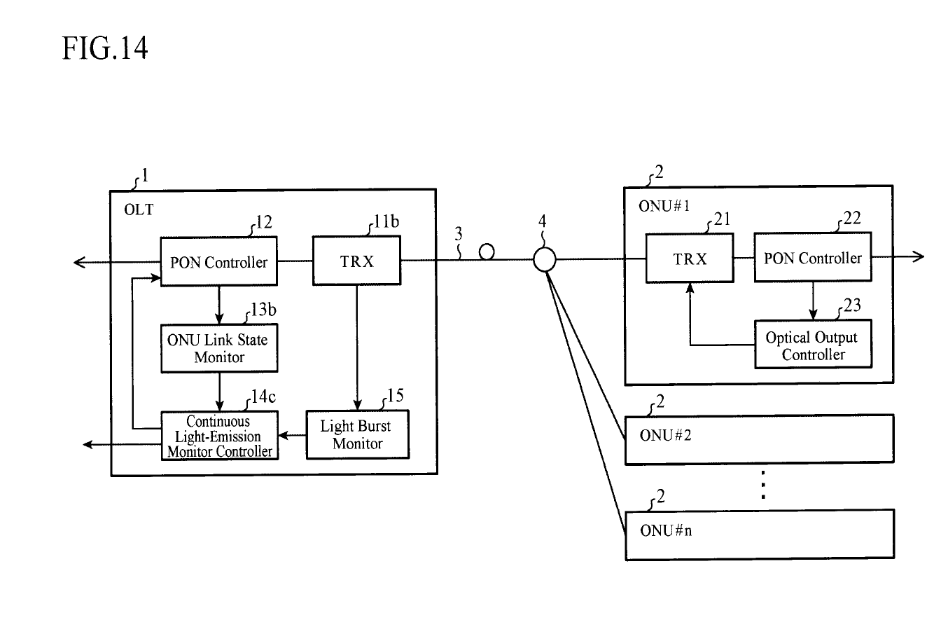

FIG. 14 is a figure illustrating a configuration of a PON system according to Embodiment 3 of the present invention. In the configuration of the PON system according to the Embodiment 3 shown in FIG. 14, the optical transmitter and receiver device 11 and the continuous light-emission monitor controller 14b of the PON system according to the Embodiment 2 of FIG. 11 are replaced with the optical transmitter and receiver device 11b and the continuous light-emission monitor controller 14c, respectively, and a light burst monitor 15 is added. The other configuration is the same as the Embodiment 2, and the same reference numerals are attached thereto and explanation thereabout is omitted.

The optical transmitter and receiver device 11b includes not only the function of the optical transmitter and receiver device 11 according to the Embodiment 1 shown in FIG. 1, but also a function of outputting a notification of a detection state of received light coming from an ONU 2.

The light burst monitor 15 performs a monitoring to determine whether received light is in burst state, namely, in continuous light-emitting state, on the basis of the received light detection state given by the optical transmitter and receiver device 11b.

The continuous light-emission monitor controller 14c has a function (as a continuous light-emission monitor) of detecting the continuous light-emitting state (an abnormal light-emission state) on the basis of a monitor result given by the light burst monitor 15 and a monitor result given by the ONU link state monitor 13b, and identifying an ONU 2 being in continuous light-emission. In addition, the continuous light-emission monitor controller 14b further has a function (as an optical output power shut down command unit) of giving a warning notification to the PON controller 12 and an optical output power shut down notification to the ONU 2 in question.

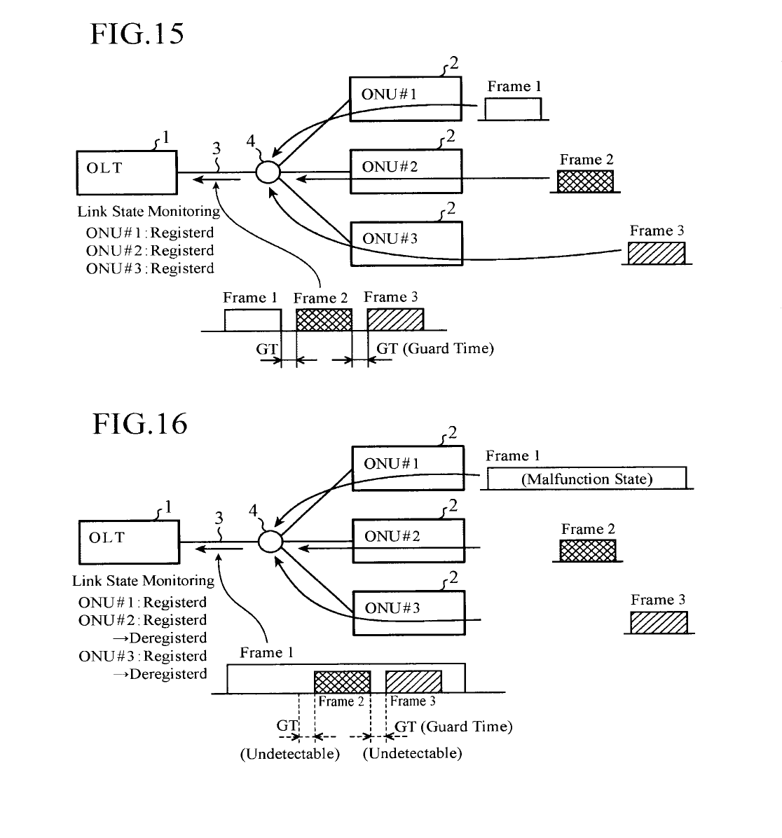

Subsequently, overview of operation of the PON system configured as described above will be explained with reference to FIGS. 15-16. Note that FIGS. 15-16 are made by adding a guard time (GT) of communication frame to FIGS. 2-3.

In FIG. 15, an uplink frame (a packet) which is input from the host terminal into each ONU 2 is transmitted to the OLT 1 at a timing on which time division control is performed. This signal is a light burst signal, and there is provided a time section, which is called a guard time (GT), where all ONUs 2 are in non-light-emission state between frames. In the normal state as shown in FIG. 15, the optical transmitter and receiver device 11b of the OLT 1 detects that the received light is in an LOS state for each GT.

On the other hand, in the continuous light-emitting state as shown in FIG. 16, for example, if an ONU #1 is continuously emitting light, this ONU #1 keeps on emitting light even in a time section which is originally GT. For this reason, the optical transmitter and receiver device 11b of the OLT 1 cannot detect non-light-emission state, and is in the state in which the received light continues. Therefore, by detecting this light burst state, the continuous light-emitting state can be detected.

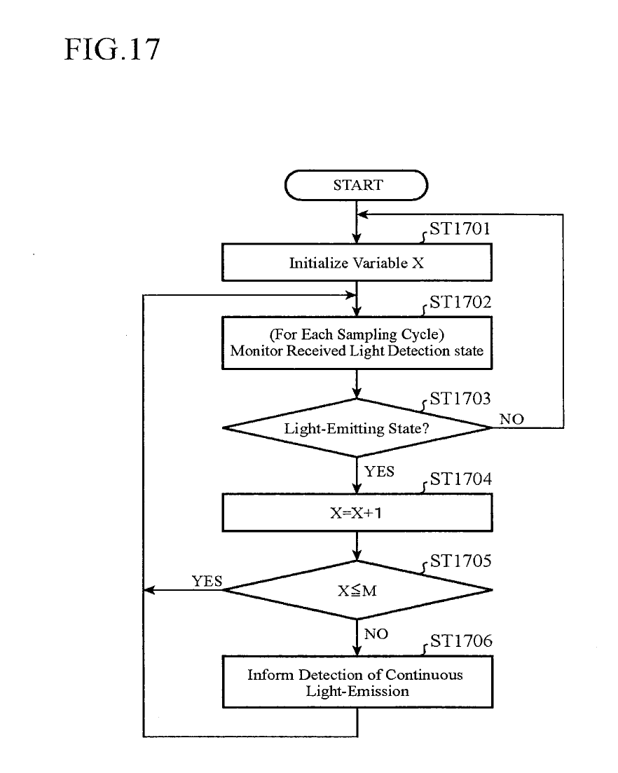

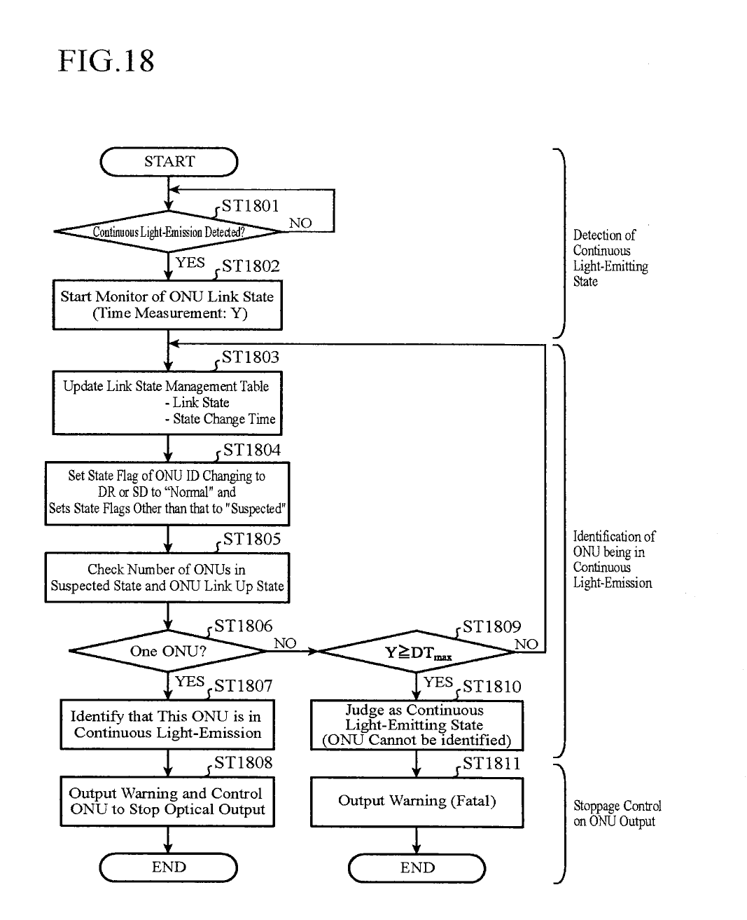

Specific operation performed by the OLT 1 will be explained with reference to FIGS. 17-18.

FIG. 17 is an example of flowchart illustrating monitor operation of the light burst monitor 15. FIG. 18 is an example of flowchart illustrating operation of monitoring by the continuous light-emission monitor controller 14c.

The optical transmitter and receiver device 11b, which has received the uplink signal from the ONU 2, notifies the light burst monitor 15 of the detection state as to the received light. For example, when the light-emission state is detected, the detection state is notified as “1” level, and when the non-light-emission state is detected, the detection state is notified as “0” level. The light burst monitor 15 operates on the basis of the example of flowchart of FIG. 17. More specifically, in the initial operation, a variable X counting duration (the number of times) of the received light detection is initialized (step ST1701).

Subsequently, with a predetermined sampling cycle, the received light detection state notification from the optical transmitter and receiver device 11 is monitored (step ST1702).

In a case where the received light detection state notification indicates the light-emission state, the sequence proceeds to step ST1704. In a case where the received light detection state notification indicates the non-light-emission state, the sequence proceeds to step ST1701 (step ST1703).

In a case where the received light detection state notification indicates the light-emission state, the received light detection continuation time (X) thereof is counted up (step ST1704).

Subsequently, in a case where the received light detection continuation time (X) is equal to or less than a predetermined numerical value M, the sequence proceeds to step ST1702. When the received light detection continuation time (X) is more than the numerical value M, the sequence proceeds to step ST1706 (step ST1705). Note that the numerical value M is determined in view of the maximum frame length of the uplink frame. Naturally, an Laser-ON/OFF Time, a preamble given to the PON section, or the like are also considered.

In the normal state as shown in FIG. 15, steps ST1702 to ST1705 are repeated for the transfer frame length, and after the frame transfer is finished, the state changes to the non-light-emission state. More specifically, since the numerical value M in step ST1705 is determined on the basis of the maximum frame length, in the determination of step ST1705 in the normal state, the processing in step ST1702 is always performed subsequently, and after the frame transfer is finished in step ST1703, step ST1701 is subsequently performed.

On the other hand, in a case of the continuous light-emitting as shown in FIG. 16, the variable X is more than the numerical value M in step ST1705, and step ST1706 is subsequently performed. Then, in step ST1706, the detection of the continuous light-emitting state is notified to the continuous light-emission monitor controller 14c.

The continuous light-emission monitor controller 14c operates based on the example of flowchart of FIG. 18. More specifically, when the continuous light-emitting state detection notification from the light burst monitor 15 is detected (step ST1801 ‘YES’), it starts counting of the monitor time of the link state (registered state) of the ONU 2 (step ST1802). The counted number Y is set in view of a delay time (the numerical value M in step ST1809) from when the light burst monitor 15 detects the continuous light-emitting state till when the ONUs 2 other than the ONU 2 in the continuous light-emitting state changes to the deregistered state.

Subsequently, the link state management table is updated on the basis of the monitor result given by the ONU link state monitor 13 (step ST1803). More specifically, the same processing as step ST1302 shown in FIG. 13 is performed.

In the updated link state management table, an ONU 2 whose state flag changes to the deregistered state or the quality deteriorated state is set to the Normal state, and those other than that are set to the Suspected state (step ST1804).

Subsequently, the number of ONUs 2, whose state flags are the Suspected state and whose link states are the registered state, is checked (step ST1805).

When the number of ONUs 2 counted in step ST1805 is one, the sequence proceeds to step ST1807, and when the number of ONUs 2 is zero or two or more, the sequence proceeds to step ST1809 (step ST1806).

In a case where the light burst monitor 15 detects the continuous light-emitting state while the ONU 2 is still the registered state, there are multiple ONUs 2 in the Suspected state and the registered state. In this case, the sequence proceeds to step ST1809. When there is only one ONU 2 that has been counted, the sequence proceeds to step ST1807, and the ONU 2 being in continuous light-emission is identified. Thereafter, in step ST1808, a warning notification indicating the continuous light-emitting state is given, and a notification of optical output power shut down command is given to the ONU 2 in question. Note that a method of commanding the optical output power shut down command to the ONU 2 and the operation of the ONU 2 thereafter are the same as those of the Embodiment 1, and explanation thereabout is omitted.

Meanwhile, in a case where step ST1809 is performed after step ST1806, when the counted number Y counted in step ST1803 is less than a predetermined maximum delay time M-seconds, the link state of the ONU 2 may still change, and therefore, step ST1803 is subsequently performed to return to the updating of the link state management table.

On the other hand, when the counted number Y reaches the maximum delay time M-seconds in step ST1809, it is recognized that the state is the continuous light-emitting state but the suspected ONU cannot be identified (step ST1810). More specifically, this may be considered as follows: while the suspected ONU is in the continuous light-emitting state, the PON controller 22 also malfunctions, and the registered state cannot be maintained, or an optical transmission device other than the ONU 2 is intentionally connected. In such case, recovery is impossible, and therefore, a warning indicating a warning (Fatal) state is notified to the operator in step ST1811.

As described above, according to this Embodiment 3, the light burst state is monitored on the basis of the detection state of the received light from the ONU 2, and when the light burst state continues for a predetermined time period of time or more, the continuous light-emitting state is configured to be detected. Therefore, even when the number of registered ONUs 2 with the OLT 1 is two or less, the continuous light-emission can be detected. In comparison to the Embodiment 1 and the Embodiment 2, the Embodiment 3 can solve wide range of situations where the continuous light-emission occurs.

It should be noted that in the invention of the present application, embodiments may be freely combined, or any given constituent elements of each embodiment may be modified, or any given constituent elements of each embodiment may be omitted, within the range of the invention.

The PON system according to the present invention employs a method for identifying an ONU being in continuous light-emission without any special detection circuit (function) in the OLT and the ONUs, and therefore, an inexpensive configuration can be made without increase in the cost, and is suitable for use with a PON system and the like in which an OLT detects abnormality of an ONU.

1. A PON system comprising:
an OLT; and
a plurality of ONUs connected to the OLT,
wherein the OLT includes:
an ONU link state monitor that monitors a registered state of each of the ONUs;
a continuous light-emission monitor that detects a continuous light-emitting state on the basis of a monitor result given by the ONU link state monitor, and identifies an ONU being in continuous light-emission; and
an optical output power shut down command unit that commands the ONU identified by the continuous light-emission monitor to shut down the optical output power, and
wherein the ONU includes:
an optical transmitter and receiver device that transmits and receives an optical signal to/from the OLT; and
a light output controller that shuts down light of the optical transmitter and receiver device in response to the command given by the optical output power shut down command unit.

2. The PON system according to claim 1, wherein, when all ONUs other than one of the plurality of ONUs changes to a deregistered state within a predetermined period of time, the continuous light-emission monitor detects the continuous light-emitting state and determines that said one of the plurality of ONUs is the ONU being in continuous light-emission.

3. The PON system according to claim 1, wherein the ONU link state monitor further monitors a transmission quality state of each of the ONUs.

4. The PON system according to claim 3, wherein, when all ONUs other than one of the plurality of ONUs changes to a deregistered state or a signal deteriorated state within a predetermined period of time, the continuous light-emission monitor detects the continuous light-emitting state and determines that said one of the plurality of ONUs is the ONU being in continuous light-emission.

5. The PON system according to claim 1, wherein
the OLT further includes a light burst monitor that monitors light burst state on the basis of a detection state of received light coming from the ONU, and
the continuous light-emission monitor detects the continuous light-emitting state on the basis of a monitor result given by the light burst monitor and a monitor result given by the ONU link state monitor, and identifies an ONU being in continuous light-emission.

6. The PON system according to claim 5, wherein, when the light burst state continues for more than a predetermined time period, the continuous light-emission monitor detects the continuous light-emitting state.

7. An OLT which is connected to a plurality of ONUs, the OLT comprising:
an ONU link state monitor that monitors a registered state of each of the ONUs;
a continuous light-emission monitor that detects a continuous light-emitting state on the basis of a monitor result given by the ONU link state monitor, and identifies an ONU being in continuous light-emission; and
an optical output power shut down command unit that commands the ONU identified by the continuous light-emission monitor to shut down the optical output power.

8. An ONU which is connected to an OLT, the ONU comprising:
an optical transmitter and receiver device that transmits and receives an optical signal to/from the OLT; and
a light output controller that shuts down light of the optical transmitter and receiver device in response to a command based on detection/identification of continuous light-emission on the basis of a registered state of the ONU itself given by the OLT.
